(19) United States
(12) Patent Application Publication
(10) Pub. No.: US 2020/0050274 A1
(43) Pub. Date: Feb. 13, 2020

(54) METHOD AND APPARATUS FOR HUMAN-MACHINE INTERACTION, TERMINAL AND COMPUTER-READABLE STORAGE MEDIUM

(71) Applicant: AAC Technologies Pte. Ltd., Singapore City (SG)

(72) Inventors: Xueli Gao, Shenzhen (CN); Xiang Ding, Shenzhen (CN)

(21) Appl. No.: 16/527,026

(22) Filed: Jul. 31, 2019

(30) Foreign Application Priority Data
Aug. 8, 2018 (CN) 201810895924.0

(51) Int. Cl. G06F 3/01; G06F 3/16

(52) U.S. Cl. CPC G06F 3/016; H04W 88/02; G06F 3/011; G06F 3/16

(57) ABSTRACT

A method and apparatus for human-machine interaction, a terminal, and a computer-readable storage medium are provided. The method for human-machine interaction is applied to the terminal, and includes: acquiring an audio signal; and generating a tactile sensing signal and a visual sensing signal according to the audio signal. The tactile sensing signal is used for providing a tactile stimulus to a user, and the visual sensing signal is used for providing a visual stimulus to the user. The terminal generates the tactile sensing signal for providing the user with the tactile stimulus and the visual sensing signal for providing the user with the visual stimulus according to the acquired audio signal, so as to enable the user to obtain different sensory experiences, enhance the sense of participation of the user, and improve the experience of the user.

### TECHNICAL FIELD

The present disclosure relate to the field of communication technologies, and more particularly, to a method and apparatus for human-machine interaction, a terminal, and a computer-readable storage medium.

### BACKGROUND

With the development of technology, electronic products are increasingly popularized and applied in people's lives, and requirements of users on experience of the electronic products are gradually increasing. For example, in the process of playing games or watching videos using a portable electronic device such as a mobile phone or a tablet, in order to improve the watching experience or gaming experience of the users, a vibrator is turned on to enhance the user experience.

However, the inventor of the present disclosure finds that the electronic products in the prior art use built-in fixed programs to turn on the vibrators to enhance the user experience. However, in practical applications, video scenes or game scenes are varied often. The users need to obtain different sensory effects according to the varied scenes, so as to enhance the sense of participation. However, the way of turning on the vibrators only by using the fixed programs cannot meet the requirements of the users.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a flow diagram of a method for human-machine interaction according to a first embodiment of the present disclosure;

FIG. 2 is a flow diagram of a method for human-machine interaction according to a second embodiment of the present disclosure;

FIG. 3 is a structural schematic view of an apparatus for human-machine interaction according to a third embodiment of the present disclosure;

FIG. 4 is a structural schematic view of an apparatus for human-machine interaction according to a fourth embodiment of the present disclosure; and

FIG. 5 is a structural schematic view of a terminal according to a fifth embodiment.

### DESCRIPTION OF EMBODIMENTS

The present disclosure will be further illustrated with reference to the accompanying drawings and the embodiments.

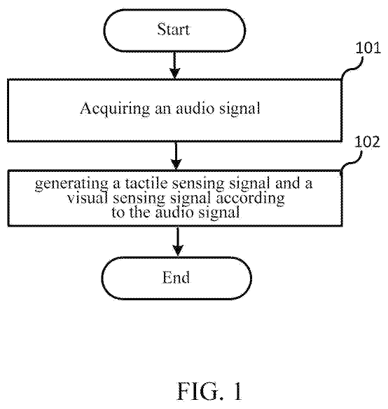

A first embodiment of the present disclosure relates to a method for human-machine interaction, which is applied to a terminal. A specific process is shown in FIG. 1, and includes the following steps.

Step 101, acquiring an audio signal.

It should be noted that the way of acquiring the audio signal in the present disclosure can be acquiring an audio signal stored locally or played in real time, or receiving an audio signal sent by an external playback device.

In one embodiment, when an application in the terminal is enabled, for example, when a game or video in the terminal is enabled, the terminal can synchronously acquire the audio signal locally according to an instruction of the game or video being enabled. The audio signal is pre-stored information related to a game or video scene.

In one embodiment, when the application in the terminal is enabled, for example, when the game or video in the terminal is enabled, the terminal can also receive an audio signal sent by an external playback device. A user can choose the type of the audio signal played by the external playback device, for example, the audio signal can be fast-tempo music or slow-tempo music. It can be understood that, if the user does not choose the type, the external playback device can also play a default form of the audio signal. Therefore, the present disclosure does not limit a specific way of acquiring the audio signal, nor does it limit a specific type of the audio signal.

Step 102, generating a tactile sensing signal and a visual sensing signal according to the audio signal, wherein the tactile sensing signal is associated with the visual sensing signal.

It should be noted that when the tactile sensing signal and the visual sensing signal are generated according to the audio signal, it is particularly possible to extract feature information of the audio signal and generate the tactile sensing signal and the visual sensing signal according to the feature information.

The tactile sensing signal is used to provide the user with a tactile stimulus, and visual sensing signal is used to provide the user with a visual stimulus.

The feature information includes at least one of signal strength, frequency and amplitude. It is particularly possible to employ a voice analysis technique to extract the signal strength of the audio signal by means of a built-in voice analysis device of the terminal and an instruction, which is preset in the terminal by the user, of extracting the signal strength when the feature information of the audio signal is extracted. Alternatively, signal frequency information is extracted according to a signal frequency instruction, or signal amplitude information is extracted according to a signal amplitude instruction. It can be understood that, the mobile terminal in the present disclosure can also convert the audio signal into data, obtain relevant data about the signal strength from the data by means of a data analysis technique, and then convert the obtained relevant data to obtain the feature information such as the signal strength. The above is described by way of an example only, and the present disclosure does not limit a specific way of extracting the feature information.

In one embodiment, a vibration state of the vibrator is determined according to the feature information such as the signal strength, and the tactile sensing signal is generated according to the vibration state of the vibrator, wherein the vibration state includes a vibration amplitude and a vibration frequency.

It should be noted that a corresponding relationship between the feature information such as the signal strength and the vibration amplitude and the vibration frequency is pre-stored in the terminal. After the audio signal is acquired and the feature information such as the signal strength of the audio signal is extracted, the extracted feature information such as the signal strength will be matched with the pre-stored corresponding relationship between the feature information such as the signal strength and the vibration amplitude, and the extracted feature information will be matched with the pre-stored corresponding relationship between the feature information such as the signal strength and the vibration frequency. The tactile sensing signal is generated according to matching results.

For example, when the signal strength is 1 to 50, the corresponding vibration amplitude is 10 μm and the corresponding vibration frequency is 5 Hz. When it is determined that the vibration amplitude is 10 μm and the vibration frequency is 5 Hz, it is defined that a primary tactile sensing signal is generated. When the signal strength is 51 to 100, the corresponding vibration amplitude is 20 μm and the corresponding vibration frequency is 10 Hz. When it is determined that the vibration amplitude is 20 μm and the vibration frequency is 10 Hz, it is defined that a secondary tactile sensing signal is generated. For example, when the audio signal is acquired and analyzed, the signal strength of the extracted audio signal is 60, at this time, the vibration state of the vibrator can be determined as follows: the vibration amplitude is 20 μm, and the vibration frequency is 10 Hz. It is determined according to the vibration state that the generated tactile sensing signal is the secondary tactile sensing signal. It can be understood that, the above is only illustrated by taking the signal strengths of 1 to 50 and 51 to 100 as examples. In practical applications, the signal strength can be divided according to actual needs. The present disclosure does not limit a specific way of dividing the signal strength.

In one embodiment, an illuminating state of the light source is determined according to the feature information such as the signal strength, and the visual sensing signal is generated according to the illuminating state of the light source, wherein the light state includes color and brightness.

It should be noted that a corresponding relationship between the feature information such as the signal strength and the color and the brightness in the illuminating state of the light source is pre-stored in the terminal. After the audio signal is acquired and the feature information such as the signal strength of the audio signal is extracted, the extracted feature information such as the signal strength will be matched with the pre-stored corresponding relationship between the feature information such as the signal strength and the brightness, and the extracted feature information such as the signal strength will be matched with the pre-stored corresponding relationship between the feature information such as the signal strength and the color. The visual sensing signal is generated according to matching results.

For example, when the signal strength is 50 to 100, the corresponding brightness is 10 cd/m² and the corresponding color is red. When it is determined that the brightness of the light source is 10 cd/m² and the color is red, it is defined that a primary visual sensing signal is generated. When the signal strength is 101 to 150, the corresponding brightness is 20 cd/m² and the corresponding color is purple. When it is determined that the brightness of the light source is 20 cd/m² and the color is purple, it is defined that a secondary visual sensing signal is generated. Therefore, when the audio signal is acquired and analyzed and when the strength of the audio signal is 60, the illuminating state of the light source can be determined as follows: the brightness is 10 cd/m² and the color is red. It is determined according to the illuminating state that the generated visual sensing signal is the primary visual sensing signal. It can be understood that, the above is only illustrated by taking the signal strengths of 50 to 100 and 101 to 150 as examples. In practical applications, the signal strength can be divided according to actual needs. The present disclosure does not limit a specific way of dividing the signal strength.

It is worth mentioning that in practical applications, the present disclosure can include a plurality of light sources, the specific number of which is set according to actual needs of the user, and is not limited in the present disclosure.

Compared with the prior art, the embodiments of the present disclosure have the advantages that the terminal generates the tactile sensing signal for providing the user with the tactile stimulus and the visual sensing signal for providing the user with the visual stimulus according to the acquired audio signal, so as to enable the user to obtain different sensory experiences, enhance the sense of participation of the user, and improve the experience of the user.

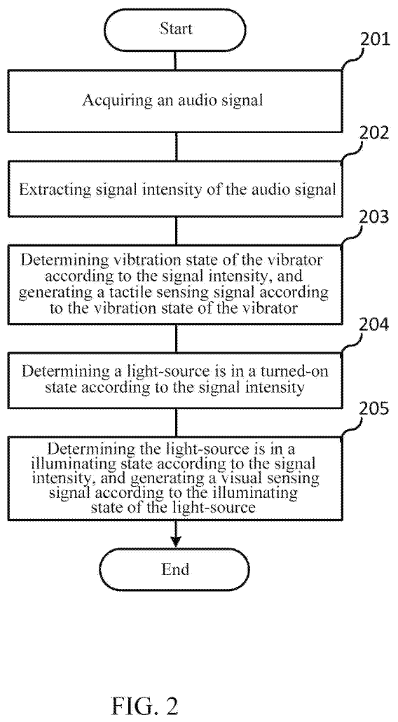

A second embodiment of the present disclosure relates to a method for human-machine interaction. This embodiment is an improvement on the basis of the first embodiment, before an illuminating state of a light source is determined according to the feature information such as the signal strength, a step of determining, according to the feature information such as the signal strength, the light source is in a turned-on state is performed. A flow diagram of the method for human-machine interaction in this embodiment is shown in FIG. 2.

Particularly, in this embodiment, steps 201 to 205 are included. The step 201 is substantially the same as the step 101 in the first embodiment, the steps 202, 203 and 205 are substantially the same as the step 102 in the first embodiment, which will not be repeated here. Differences will be mainly described below. Technical details which are not described in detail in this embodiment can refer to the method for human-machine interaction provided in the first embodiment, which will not be repeated here.

Step 204, determining, according to the feature information such as the signal strength, the light source is in a turned-on state.

In one embodiment, after extracting the feature information such as the signal strength of the audio signal, the terminal will determine, according to the feature information such as the signal strength, the light source is in the turned-on state.

In one embodiment, the extracted feature information such as the signal strength is compared with a preset threshold, and if the extracted feature information such as the signal strength is greater than the preset threshold, then it is determined that the light source is in the turned-on state.

For example, the preset threshold of the signal strength is set to 40, when the extracted signal strength is greater than 40, it is determined that the light source is in the turned-on state, and when the extracted signal strength is less than 40, it is determined that the light source is in a turned-off state.

It should be noted that, in this embodiment, when the extracted feature information such as the signal strength is less than the preset threshold, the light source will be in the turned-off state, but the vibrator will vibrate. At this time, the terminal will generate the tactile sensing signal accordingly, while the visual sensing signal is 0. When this state occurs, the feature information such as the signal strength is relatively weak, and the user can directly judge the magnitude of the feature information such as the signal strength according to the tactile stimulus brought by the tactile sensing signal and the visual stimulus that cannot be obtained.

It should be noted that the order of the steps 203-205 is not limited in this embodiment. The purpose of this embodiment is met as long as it is determined that the step 204 is performed before the step 205.

Compared with the prior art, the embodiments of the present disclosure have the advantages that the terminal generates the tactile sensing signal for providing the user with the tactile stimulus and the visual sensing signal for providing the user with the visual stimulus according to the acquired audio signal, so as to enable the user to obtain different sensory experiences, enhance the sense of participation of the user, and improve the experience of the user. Moreover, before the illuminating state of the light source is determined according to the feature information such as the signal strength, a step of determining, according to the feature information such as the signal strength, the light source is in the turned-on state can be performed, which avoids the redundant operation of the terminal to the light source in the turned-off state.

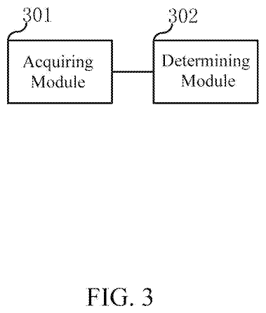

A third embodiment of the present disclosure relates to an apparatus for human-machine interaction, a specific structure of which is shown in FIG. 3. The apparatus for human-machine interaction particularly includes an acquiring module 301 and a determining module 302.

The acquiring module 301 is configured to acquire an audio signal.

The determining module 302 is configured to generate a tactile sensing signal and a visual sensing signal according to the audio signal, wherein the tactile sensing signal is associated with the visual sensing signal.

The tactile sensing signal is used to provide a user with a tactile stimulus, and the visual sensing signal is used to provide the user with a visual stimulus.

It is apparent that this embodiment is an apparatus embodiment corresponding to the first embodiment, and can be implemented in coordination with the first embodiment. The relevant technical details mentioned in the first embodiment are still effective in this embodiment, which will be omitted here in order to reduce the repetition. Accordingly, the related technical details mentioned in this embodiment may also be applied in the first embodiment.

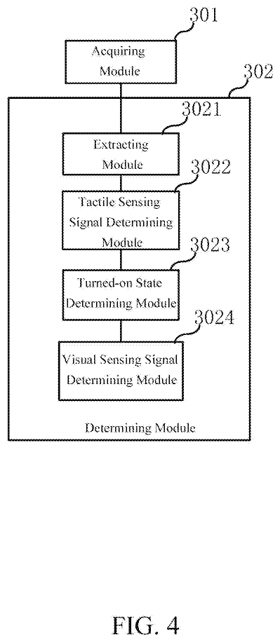

A fourth embodiment of the present disclosure relates to an apparatus for human-machine interaction. This embodiment is substantially the same as the third embodiment. A specific structure of the apparatus for human-machine interaction is shown in FIG. 4. The main improvement is to specify the function of the determining module 302.

The determining module 302 includes an extracting module 3021, a tactile sensing signal determining module 3022, a turned-on state determining module 3023 and a visual sensing signal determining module 3024.

The extracting module 3021 is configured to extract feature information such as signal strength of an audio signal.

The tactile sensing signal determining module 3022 is configured to determine a vibration state of a vibrator according to the feature information such as the signal strength, and generate a tactile sensing signal according to the vibration state of the vibrator.

The turned-on state determining module 3023 is configured to determine, according to the feature information such as the signal strength, the light source is in a turned-on state.

The visual sensing signal determining module 3024 is configured to determine the illuminating state of the light source according to the feature information such as the signal strength, and generate the visual sensing signal according to the illuminating state of the light source.

It is apparent that the present embodiment is an apparatus embodiment corresponding to the second embodiment, which can be implemented in coordination with the second embodiment. The relevant technical details mentioned in the second embodiment are still effective in the present embodiment, which will be omitted here in order to reduce the repetition. Accordingly, the related technical details mentioned in the present embodiment may also be applied in the second embodiment.

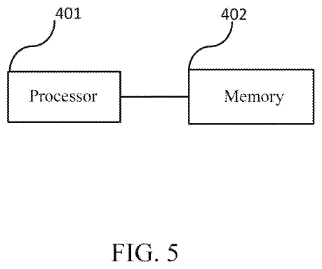

A fifth embodiment of the present disclosure relates to a terminal, a specific structure of which is shown in FIG. 5. The terminal includes at least one processor 401; and a memory 402 communicatively connected with at least one processor 401. The memory 402 stores an instruction executable by the at least one processor 401, and the instruction is executed by the at least one processor 401 to enable the at least one processor 401 to perform a method for human-machine interaction.

In this embodiment, the processor 401 takes a central processing unit (CPU) as an example, and the memory 402 takes a random access memory (RAM) as an example. The processor 401 and the memory 402 can be connected via a bus or by other means, and be connected via a bus in FIG. 5 as an example. As a non-volatile computer-readable storage medium, the memory 402 can be used to store a non-volatile software program, a non-volatile computer-executable program and a module. For example, a program implementing a method for determining environmental information in the embodiment of the present disclosure is stored in the memory 402. The processor 401 executes various functional applications and data processing of devices by running the non-volatile software program, the instruction and the module stored in the memory 402, that is, implements the method for human-machine interaction described above.

The memory 402 may include a storage program area and a storage data area, the storage program area may store applications required by an operating system or at least one function, and the storage data area may store a list of options, etc. Furthermore, the memory may include a high-speed random access memory, and may further include a non-volatile memory, such as at least one disk memory device, a flash memory device, or other non-volatile solid-state memory devices. In some embodiments, the memory 402 optionally includes memories set remotely relative to the processor 401 that can be connected to an external device over a network. Examples of the above networks include, but are not limited to, the Internet, the intranet, a local area network, a mobile communication network and combinations thereof.

One or more program modules are stored in the memory 402, and when being executed by the one or more processors 401, perform the method for human-machine interaction in any of the method embodiments described above.

The above product can perform the method provided in the embodiments of the present disclosure, and has the corresponding functional modules and beneficial effects of performing the method. Technical details which are not described in detail in this embodiment can refer to the method provided in the embodiments of the present disclosure.

A sixth embodiment of the present disclosure relates to a computer-readable storage medium in which a computer program is stored, wherein when being executed by a processor, the computer program can implement the method for human-machine interaction involved in any of the method embodiments of the present disclosure.

It will be understood by those skilled in the art that all or a part of steps in the method of the above embodiments can be done by instructing the relevant hardware through a program stored in a storage medium, the program includes a number of instructions to enable a device (which may be a single-chip machine, a chip, etc.) or a processor to perform all or a part of the steps of the method described in the various embodiments of the present disclosure. The aforementioned storage medium includes a U disk, a mobile hard disk, a read-only memory, a random access memory, a disk or a CD-ROM, which can store programming codes.

It will be understood by those ordinarily skilled in the art that the above embodiments are specific embodiments implementing the present disclosure, and in practical applications, various changes can be made in form and detail without departing from the spirit and scope of the present disclosure.

What is claimed is:

1. A method for human-machine interaction, applied to a terminal, the method comprising:
acquiring an audio signal; and
generating a tactile sensing signal and a visual sensing signal according to the audio signal,
wherein the tactile sensing signal is associated with the visual sensing signal, the tactile sensing signal is used for providing a tactile stimulus to a user, and the visual sensing signal is used for providing a visual stimulus to the user.

2. The method for human-machine interaction as described in claim 1, wherein said generating a tactile sensing signal and a visual sensing signal according to the audio signal comprises:
extracting feature information of the audio signal; and
generating the tactile sensing signal and the visual sensing signal according to the feature information.

3. The method for human-machine interaction as described in claim 2, wherein the feature information comprises at least one of signal strength, frequency and amplitude.

4. The method for human-machine interaction as described in claim 3, wherein said generating a tactile sensing signal and a visual sensing signal according to the feature information comprises:
determining a vibration state of a vibrator according to the feature information, and generating the tactile sensing signal according to the vibration state of the vibrator, the vibration state comprising a vibration amplitude and a vibration frequency; and
determining an illuminating state of a light source according to the feature information, and generating the visual sensing signal according to the illuminating state of the light source, the illuminating state involving color and brightness.

5. The method for human-machine interaction as described in claim 4, further comprising, prior to said determining an illuminating state of a light source according to the feature information:
determining, according to the feature information, the light source is in a turned-on state.

6. The method for human-machine interaction as described in claim 1, wherein said acquiring an audio signal comprises: acquiring a local audio signal.

7. The method for human-machine interaction as described in claim 1, wherein said acquiring an audio signal comprises: receiving an audio signal sent by an external playback device.

8. An apparatus for human-machine interaction, comprising:
an acquiring module configured to acquire an audio signal; and
a determining module configured to generate a tactile sensing signal and a visual sensing signal according to the audio signal, wherein the tactile sensing signal is associated with the visual sensing signal, and
wherein the tactile sensing signal is used for providing a tactile stimulus to a user, and the visual sensing signal is used for providing a visual stimulus to the user.

9. A terminal, comprising:
at least one processor; and
a memory communicatively connected with the at least one processor,
wherein the memory stores an instruction executable by the at least one processor, and the instruction is executed by the at least one processor to cause the at least one processor to perform the method for human-machine interaction as described in claim 1.
